(19) United States
(12) Patent Application Publication
(10) Pub. No.: US 2016/0178267 A1
(43) Pub. Date: Jun. 23, 2016

(54) REFRIGERATOR

(71) Applicant: BSH HAUSGERÄTE GMBH, München (DE)

(72) Inventors: Jingpeng HAO, Chuzhou (CN); Songtao LU, Chuzhou (CN)

(21) Appl. No.: 14/908,912

(22) PCT Filed: Jul. 17, 2014
(86) PCT No.: PCT/IB2014/063186

§ 371 Date: Jan. 29, 2016

(30) Foreign Application Priority Data
Jul. 31, 2013 (CN) 201320466203.0

(51) Int. Cl. F25D 23/02; E05D 13/00

(52) U.S. Cl. CPC F25D 23/028; E05D 13/1276; F25D 2201/12

(57) ABSTRACT

The present invention provides a refrigerator, having a door (1), where one side of the door (1) is connected to a rotatable mullion bar (20), a cable (23, 33) is arranged inside the mullion bar (20), and the cable (23, 33) is connected to the inside of the door (1) by a cable-connecting part (32) between the mullion bar (20) and the door (1). According to the present invention, a shell forming the mullion bar (20) has a first accommodating part (31) that extends along a rotation axis (44) of the mullion bar, and the cable (23, 33) is at least partially received in the first accommodating part (30).

### BACKGROUND

1. Technical Field

The present invention relates to the field of household appliances, and in particular, to a refrigerator having a mullion bar.

2. Related Art

A problem exists in a multi-door refrigerator: there is a gap between doors that are arranged on the left and right sides, and leakage of cool air needs to be prevented. A common method is to pivotally arrange a sealing mullion bar on one of the doors, and the mullion bar needs to pivot to a certain angle in the process of opening or closing the door. To ensure that the mullion bar can pivot normally, a torsion spring is arranged on a pivot between the mullion bar and the door, so that the mullion bar is maintained in a pivoting state under an elastic force of the torsion spring. To prevent formation of dew or frost on the mullion bar, a heating wire is arranged inside the mullion bar, and a cable is introduced from the outside of the mullion bar to provide power for the heating wire. As the number of times of rotation of the mullion bar increases, the cable is easily worn out or even broken, which affects defrosting of the mullion bar and results in potential electrical hazards.

### SUMMARY

To solve at least one problem in the prior art, the present invention provides a refrigerator which has a good appearance and can reduce potential electrical hazards caused by rotation of the mullion bar.

To achieve the foregoing objectives, the present invention provides a refrigerator, having a door, where one side of the door is connected to a rotatable mullion bar, a cable is arranged inside the mullion bar, and the cable is connected to the inside of the door by a cable-connecting part between the mullion bar and the door, characterized in that a shell forming the mullion bar has a first accommodating part that extends along a rotation axis of the mullion bar, and the cable is at least partially received in the first accommodating part.

A part of the cable is received in the first accommodating part that extends along the rotation axis of the mullion bar, and when the mullion bar rotates, the rotation axis of the mullion bar passes through the first accommodating part, and the part of the cable can rotate along with the rotation of a rotatable part of the cable-connecting part, where the part of the cable and the rotatable part rotate about a same rotation axis, so that excessive friction between the cable and the rotatable part of the cable-connecting part is prevented, thereby prolonging the service life of the cable. Because a part of the cable is received in the first accommodating part, the cable is kept away from a heat insulation part and a connecting part inside the mullion bar, so that the arrangement of the heat insulation part and the connecting part inside the mullion bar is not affected by the layout of the cable, which is conducive to the manufacturing consistency of products.

Optionally, the cable between the heating wire and the cable-connecting part is bent at least once to form a first segment and a second segment, where the second segment close to the cable-connecting part is almost completely located inside the first accommodating part. The bending is carried out in the following manner: the cable directly extends from the connecting point with the heating wire to the first accommodating part, and then is bent to form the second segment, so that the second segment passes along an extending direction of the first accommodating part until it passes through the cable-connecting part. The length of the second segment of the cable that is located inside the first accommodating part should be as long as possible, because provided that the rotating amplitude is fixed, the longer the cable length is, the smaller the amount of deformation per unit length of the cable is. Another cable bending manner is: the cable firstly extends a small distance in a direction away from the cable-connecting part, and then is bent and enters the first accommodating part. According to this manner, the length of the second segment of the cable is increased while making use of the space of the first accommodating part as much as possible, so that the amount of deformation per unit length of the cable located inside the first accommodating part is minimized during rotation.

Optionally, the second segment of the cable is parallel to the rotation axis of the mullion bar, so as to reduce friction between the cable and the cable-connecting part during rotation.

Optionally, the shell of the mullion bar further has a second accommodating part for accommodating a part of the cable-connecting part, and a shell of the second accommodating part extends along the rotation axis of the mullion bar to form a shell of the first accommodating part. In this way, a good appearance is provided, and there is no gap between the second accommodating part and the first accommodating part, which is conducive to the protection of the cable.

Optionally, at least a pivot mechanism is further arranged between the door and the mullion bar, the shell of the first accommodating part further extends along the rotation axis of the mullion bar to form a third accommodating part, and the rotatable part of the pivot mechanism is received in the third accommodating part. The pivot mechanism enhances the strength of connection between the mullion bar and the door. In addition, two pivot mechanisms may be arranged in symmetry on two sides of the cable-connecting part, and to prevent excessive extension of the protruding shell, the accommodating part of the other pivot mechanism is arranged independently.

Optionally, the pivot mechanism is a pivot mechanism having a torsion spring.

Optionally, the shell of the second accommodating part, the shell of the first accommodating part, and the shell of the third accommodating part form an integral structure, which provides a good appearance and is easy to manufacture.

Optionally, a heating wire is arranged inside the mullion bar, a fixing part is arranged at a position where the heating wire and the cable are connected, and one end of the cable is fixed onto the fixing part.

Optionally, a part of the cable-connecting part is a hollow cylinder, which is received in the second accommodating part. The second segment of the cable that is received in the first accommodating part may enter a hollow passageway inside the cylinder in a parallel manner, so that friction between the cable and the rotatable part of the cable-connecting part during rotation can be prevented as much as possible.

Optionally, the cable passes through the cable-connecting part and is connected to a control apparatus located inside the door.

The structure, other objectives and beneficial effects of the present invention will be more readily understood from the description of the preferred embodiments with reference to the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of a door having a mullion bar according to the present invention;

FIG. 2 is a cross-sectional view of part B in FIG. 3 according to a first embodiment; and

FIG. 3 is a cross-sectional view of part B in FIG. 3 according to a second embodiment.

### DETAILED DESCRIPTION

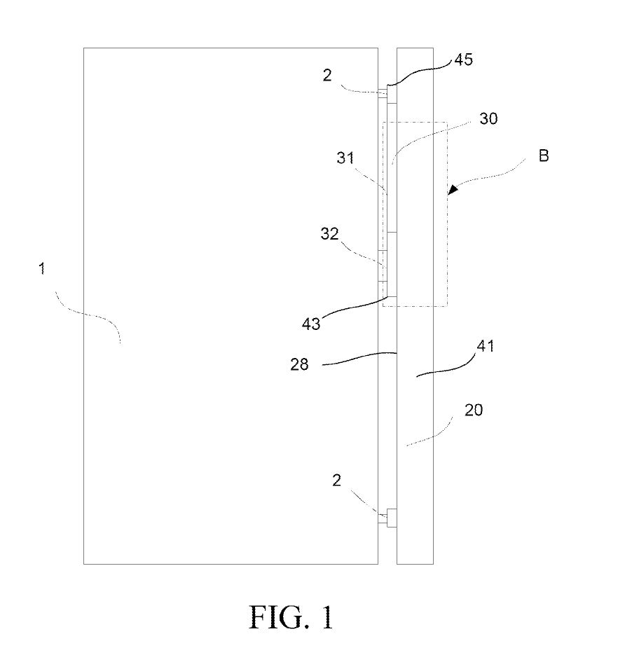

To make the objectives, solutions and beneficial effects of the present invention more comprehensible, the present invention is further described below with reference to FIG. 1 to FIG. 3 and preferred embodiments.

FIG. 1 is a schematic structural view of a door having a mullion bar according to the present invention, where the door is one of doors of a side-by-side refrigerator. The right side of a door 1 is connected to a rotatable mullion bar 20, and the mullion bar 20 is connected to a right edge of the door 1 through two pivot mechanisms 2 and one cable-connecting part 32. The two pivot mechanisms 2 are arranged in symmetry relative to the cable-connecting part 32, both of the two pivot mechanisms 2 are pivot mechanisms having a torsion spring, and the mullion bar is maintained in a pivoting state under an elastic force of the torsion spring. When the door is open, the mullion bar 20 rotates to a state of being perpendicular to the door 1; when the door 1 is closed, the mullion bar 20 restores a state of being parallel to the door 1, that is, the state shown in FIG. 1. Because the purpose of arranging the mullion bar 20 is to prevent leakage of cool air due to the existence of a gap between the left door and the right door of the side-by-side refrigerator, a heat insulation material needs to be filled in the mullion bar 20; in addition, to prevent the icing phenomenon caused by formation of dew on the mullion bar 20, a heating wire used for removing dew further needs to be arranged inside the mullion bar. The heating wire is coiled inside the mullion bar, and is connected to a control apparatus located inside the door 1 by a cable to provide power for the heating wire. The cable extends out of the cable-connecting part of the mullion bar 20 and is then connected to the inside of the door.

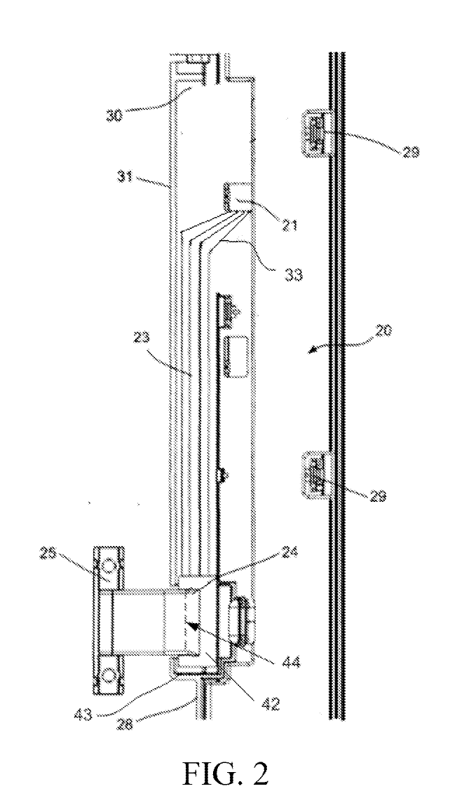

A rotatable part 24 (as shown in FIG. 2) of the cable-connecting part is received in a second accommodating part 42, and a shell 43 forming the second accommodating part is arranged in a protruding manner on a sidewall 28 of a main body of the mullion bar; a shell 31 forming a first accommodating part is generally at the same height as the shell 43 forming the second accommodating part. The first accommodating part 30 is used for receiving a cable 23 that provides power for the heating wire. The shell 43 forming the second accommodating part may also extend along a rotation axis 44 of the mullion bar to form the shell 31 forming the first accommodating part, and the shell 31 forming the first accommodating part may further extend to form a shell 45 of a third accommodating part for receiving the pivot mechanism 2. Therefore, in FIG. 1, the shell 43 of the second accommodating part, the shell 31 of the first accommodating part, and the shell 45 of the third accommodating part form an integral structure, which provides a good appearance and is easy to manufacture.

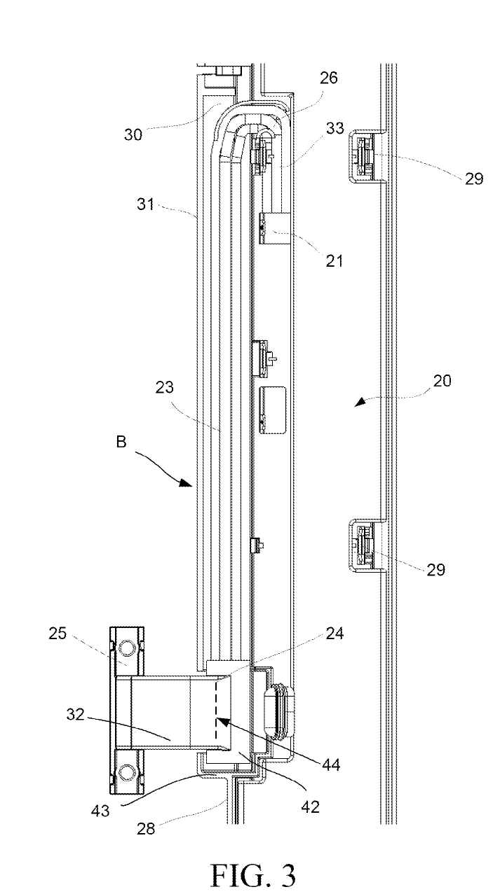

FIG. 2 and FIG. 3 are enlarged cross-sectional views of part B in FIG. 1 according to a first embodiment and a second embodiment. First referring to the first embodiment shown in FIG. 2, the mullion bar 20 is formed by two shells fastened by a buckle 29. The heating wire is arranged inside one of the shells, and the heating wire and the cable 23, 33 that provides power for the heating wire are connected at a fixed point 21. The fixed point 21 is arranged fixedly on the shell of mullion bar 20. The cable 23, 33 extending from the fixed point 21 is directly introduced into the first accommodating part 30, and is bent once to extend in a direction parallel to the extending direction of the first accommodating part 30, and finally reaches the rotatable part 24 of the cable-connecting part. The cable before the bending point is defined as a first segment 33 and the cable after the bending point is defined as a second segment 23. To improve stability, a fixing apparatus may be arranged at the bending point to fix the cable 23, 33 onto the shell of the mullion bar 20, so as to prevent translational movement of the cable 23, 33. In this embodiment, an obtuse angle is formed between the first segment 33 and the second segment 23, and most preferably, a right angle is formed between the first segment 33 and the second segment 23, so that for this cable layout manner, the length of the second segment 23 of the cable is maximized. A long torsion area allows the cable to undergo a small amount of deformation per unit length, so that the cable is protected. The cable 23, 33 sequentially passes through the rotatable part 24 of the cable-connecting part and a fixing part 25 fixed to the door 1, and is then connected to the control apparatus located inside the door 1. The rotatable part 24 of the cable-connecting part is a thin-wall hollow cylinder, and the cable enters a hollow passageway formed by the hollow cylinder, and then after being bent by almost 90 degrees, enters the fixing part 25. A passageway for the cable to pass through is also arranged inside the fixing part 25. In the second embodiment shown in FIG. 3, the cable 23, 33 extends from the fixed point 21 in a direction away from the cable-connecting part 32 to form a first segment 33, and then the first segment 33 is bent to form an approximate arc 26 and extends to form a second segment 23 that extends toward the cable-connecting part. The second segment 23 is received in the first accommodating part 30, and is parallel to the rotation axis 44 of the mullion bar 20. According to this cable layout manner, the length of the second segment 23 of the cable is much longer than that of the first embodiment, so that a longer torsion area is formed, which helps prolong the service life of the cable.

1. A refrigerator, having a door, wherein one side of the door is connected to a rotatable mullion bar, a cable is arranged inside the mullion bar, and the cable is connected to the door by a cable-connecting part between the mullion bar and the door, wherein a shell forming the mullion bar his provided with a first accommodating part that extends along a rotation axis of the mullion bar, and the cable is at least partially received in the first accommodating part.

2. The refrigerator according to claim 1, wherein the cable inside the mullion bar is bent at least once to form a first segment and a second segment, wherein the second segment close to the cable-connecting part is almost completely located inside the first accommodating part.

3. The refrigerator according to claim 2, wherein the second segment of the cable is parallel to the rotation axis of the mullion bar.

4. The refrigerator according to claim 1, wherein the shell of the mullion bar further has a second accommodating part for accommodating a part of the cable-connecting part, and a shell of the second accommodating part extends along the rotation axis of the mullion bar to form a shell of the first accommodating part.

5. The refrigerator according to claim 4, wherein at least a pivot mechanism is further arranged between the door and the mullion bar, the shell of the first accommodating part further extends along the rotation axis of the mullion bar to form a third accommodating part, and a rotatable part of the pivot mechanism is received in the third accommodating part.

6. The refrigerator according to claim 5, wherein the pivot mechanism is a pivot mechanism having a torsion spring.

7. The refrigerator according to claim 5, wherein the shell of the second accommodating part, the shell of the first accommodating part, and a shell of the third accommodating part form an integral structure.

8. The refrigerator according to claim 1, wherein a part of the cable-connecting part is a hollow cylinder, which is received in the second accommodating part.

9. The refrigerator according to claim 1, wherein a heating wire is arranged inside the mullion bar, a fixing part is arranged at a position where the heating wire and the cable are connected, and one end of the cable is fixed onto the fixing part.

10. The refrigerator according to claim 1, wherein the cable passes through the cable-connecting part and is connected to a control apparatus located inside the door.
